(19) United States
(12) Patent Application Publication
(10) Pub. No.: US 2026/0246352 A1
(43) Pub. Date: Aug. 20, 2026

(54) STATOR MODULE AND PLANAR DRIVE SYSTEM

(71) Applicant: Beckhoff Automation GmbH, Verl (DE)

(72) Inventors: Lukas Bentfeld, Delbrück (DE); Rolf Brinkmann, Bad Salzuflen (DE); Tim Kaulmann, Paderborn (DE)

(21) Appl. No.: 19/669,006

(22) Filed: May 6, 2026

Related U.S. Application Data
(63) Continuation of application No. PCT/EP2024/082072, filed on Nov. 12, 2024.

(30) Foreign Application Priority Data
Nov. 13, 2023 (DE) 10 2023 131 529.3

(51) Int. Cl. H02K 41/02; H02K 1/16; H02K 11/21; H02K 11/33

(52) U.S. Cl. CPC H02K 41/02; H02K 1/16; H02K 11/21; H02K 11/33; H02K 2201/18; H02K 2211/03

(57) ABSTRACT

A stator module for electromagnetically driving a rotor in a planar drive system includes a stator plate, a power unit with at least one printed circuit board projecting downwards from a stator plate bottom side, a feedback board in which a feedback board passage grid is provided, and a box-shaped cooling unit with a heat conducting plate having a projecting circumferential surround. A heat conducting plate receiving grid is provided in the heat conducting plate.

### CROSS-REFERENCE TO RELATED APPLICATIONS

This application is a continuation of International Patent Application Number PCT/EP2024/082072, filed Nov. 12, 2024, entitled “Stator Module and Planar Drive System,” which claims priority to German patent application DE 10 2023 131 529.3, filed Nov. 13, 2023, entitled “Statormodul und Planarantriebssystem,” each of which is incorporated by reference herein, in the entirety and for all purposes.

### FIELD

The invention relates to a stator module of a planar drive system and to a planar drive system having a stator module.

### BACKGROUND

Planar drive systems are used in automation technology, among other things, to move a movable element of a system or of a machine in at least two linearly independent directions. Planar drive systems may comprise a permanently energized electromagnetic planar motor, wherein the planar motor comprises a stator with a flat, planar surface and a rotor that may move over the surface in two directions.

In the electromagnetic planar motor, the drive force upon the rotor is generated with the aid of conductors arranged in a fixed position on the stator, through which a drive current flows and which interact with drive magnets arranged on the rotor. In order to generate the drive current required to move the rotor, the stator usually comprises one or a plurality of current-generating units.

In order to detect the position of the rotor above the stator, the planar drive system may comprise a position-detecting unit arranged at the stator that interacts with the rotor. Such an interaction may, for example, take place magnetically with the aid of magnetic field sensors and magnets arranged on the rotor. In order to accurately determine the position of the rotor, the interaction between the rotor and the position-detecting unit should be recorded with the highest possible signal-to-noise ratio.

The planar stator of the planar drive system may be embodied as a stator module, which comprises a stator assembly having the current-carrying conductors as well as electronic components for generating the drive current and for detecting the position of the rotor. The stator assembly with the conductors through which the drive current flows is arranged on the top of the stator module. The electronic components for generating the drive current and for detecting the position of the rotor are then arranged under the stator assembly in the stator module. In order to be able to transmit sufficient force to the rotor, drive currents with high amperage must sometimes be generated. This may lead to high resistance losses in the conductors through which the current flows and thus to the stator module heating up considerably. The drive current is also usually generated as an alternating current. This may lead to high alternating electromagnetic fields, which may interfere with electronic components arranged on the stator. As a result, proper operation cannot be guaranteed.

A stator module and a planar drive system according to the described state of the art are known, for example, from DE 102017131314 A1.

### SUMMARY

The invention provides an improved stator assembly for a planar drive system and a compact planar drive system.

According to a first aspect, a stator module for electromagnetically driving a rotor in a planar drive system includes a stator plate which comprises a coil conductor, to which a drive current may be applied, for generating a magnetic field driving the rotor via a stator plate top side and at least one stator plate connecting device arranged on a stator plate bottom side for feeding in the drive current, a power unit which faces the stator plate bottom side and comprises at least one circuit board, the circuit board projecting downwards from the stator plate bottom side. The printed circuit board comprises a drive current printed circuit board connecting device for electrical contacting with the stator plate connecting device for drive current output and a control signal printed circuit board connecting device for control signal input.

The circuit board comprises circuit board power devices for generating drive current based on input control signals and input power, and a feedback board which comprises at least one sensor component for detecting the position of the rotor and a feedback communication device for generating control signals and processing data. A feedback board passage grid is provided in the feedback board, wherein the feedback board comprises at least one feedback board connecting device for data contacting with the control signal circuit board connecting device for control signal output, and a box-shaped cooling unit which comprises a heat conducting plate with a projecting circumferential surround and heat conducting structure elements on a heat conducting plate top side, a heat conducting plate receiving grid being provided in the heat conducting plate, the stator plate bottom side abutting on the surround of the cooling unit.

A feedback board bottom side is arranged on the heat conducting plate top side and the heat conducting structure elements of the heat conducting plate engage through the feedback board passage grid and abut against the stator plate bottom side. The circuit board of the power unit engages at least partially through the feedback board passage grid and engages in the heat conducting plate receiving grid.

According to a second aspect, a stator module for electromagnetically driving a rotor in a planar drive system comprises a stator plate, a power unit, which comprises at least one printed circuit board projecting downwards from a stator plate bottom side, a feedback board, in which a feedback board passage grid is provided, and a box-shaped cooling unit, which comprises a heat conducting plate having a projecting circumferential surround, wherein a heat conducting plate receiving grid is provided in the heat conducting plate, wherein the stator plate bottom side abuts on the surround of the cooling unit.

According to a third aspect, a planar drive system comprises a plurality of stator modules and at least one rotor, wherein each stator module comprises a stator plate, a power unit, which comprises at least one printed circuit board projecting downwards from a stator plate bottom side, a feedback board, in which a feedback board passage grid is provided, and a box-shaped cooling unit, which comprises a heat conducting plate having a projecting circumferential surround, wherein a heat conducting plate receiving grid is provided in the heat conducting plate, wherein the stator plate bottom side abuts on the surround of the cooling unit, and wherein the plurality of stator modules form a joint surface on which the rotor may be moved.

### EXAMPLES

A stator module for electromagnetically driving a rotor in a planar drive system comprises a stator plate, which comprises a coil conductor to which a drive current may be applied for generating a magnetic field driving the rotor via a stator plate top side and at least one stator plate connecting device arranged on a stator plate bottom side for supplying drive current. The stator module further comprises a power unit facing the stator plate bottom side, which comprises at least one circuit board, the circuit board protruding downwards, in particular vertically, from the stator plate bottom side.

The printed circuit board comprises a drive current printed circuit board connecting device for electrical contacting with the stator plate connecting device for drive current output and a control signal printed circuit board connecting device for control signal input. At least one circuit board comprises circuit board power components for generating a drive current on the basis of fed-in control signals and fed-in power. The stator module further comprises a feedback board, which comprises at least one, but in particular a plurality of sensor components for detecting the position of the rotor and a feedback communication device for generating control signals and processing data, wherein a feedback board passage grid is provided in the feedback board. The feedback circuit board comprises at least one feedback circuit board connecting device for data contacting with the control signal circuit board connecting device for control signal output.

The stator module further comprises a box-shaped cooling unit having a heat conducting plate with a protruding circumferential surround and heat conducting structure elements on a heat conducting plate top side, wherein a heat conducting plate receiving grid is provided in the heat conducting plate, which is connected to a heat conducting plate receiving structure on a heat conducting plate bottom side, wherein the stator plate bottom side rests on the surround of the cooling unit, wherein a feedback board bottom side is arranged on the heat conducting plate top side and the heat conducting structure elements of the heat conducting plate penetrate the feedback board through-grid and abut against the stator plate bottom side. The circuit board of the power unit passes at least partially through the feedback board passage grid and engages with the heat conducting plate receiving grid.

With the aid of the connecting concept and the arrangement of the circuit board of the power unit in the feedback board, the distance between the rotor sensor components may be freely adjusted. The distance may be adjusted without changing the circuit board of the power unit or the feedback board by changing the surround of the cooling unit. When manufacturing the stator module, the feedback board may first be placed on the heat conducting plate of the cooling unit and then the feedback board may be connected to the circuit board of the power unit. This allows for the feedback board and thus the sensor components to be positioned very precisely.

The power unit may comprise a plurality of rectangular circuit boards, the circuit boards forming a grid pattern oriented at a right angle with respect to the stator plate bottom side. When the rotor moves over the stator surface, unwanted eddy current braking effects may occur in an underlying metal structure such as is present in the circuit boards. Eddy current effects are prevented by the vertical arrangement of the circuit boards in the power unit. Furthermore, the vertical arrangement of the PCBs means that PCB power components containing ferromagnetic materials may be placed further away from the stator plate. This prevents the sensor components from being influenced by very rapidly changing magnetic fields. The vertical arrangement also allows for the surface area of the circuit boards in the power unit to be increased as required without thermally insulating the stator surface from the cooling unit.

The circuit boards of the power unit each comprise a circuit board insertion gap on their first circuit board outer edge facing the stator plate bottom side or on their second circuit board outer edge facing the feedback board top side, the width of which essentially corresponds to the thickness of a circuit board, and wherein circuit boards of the first-mentioned embodiment are inserted with their circuit board insertion gaps into circuit board insertion gaps of circuit boards of the second-mentioned embodiment in order to form the grid pattern. With this circuit board embodiment, cross-grid or grid-grid connections of circuit boards may be produced, which ensure a high mechanical stability of the power unit.

Each printed circuit board may comprise a first outer edge of the printed circuit board, which rests against the bottom side of the stator plate, wherein each printed circuit board may have a printed circuit board groove with a support edge on a second outer edge of the printed circuit board opposite the first outer edge of the printed circuit board, which rests against the top side of the feedback board. This embodiment ensures improved positioning of the feedback board on the circuit boards of the power unit.

The at least one feedback board connecting device for the control signal output may be embodied as a flex connector. The flex connector embodiment makes it possible to flexibly adjust the insertion depth of the circuit boards of the power unit in the feedback board and, as the case may be, to easily adapt it. Flex connectors are characterized by a flat cable-like connecting structure and are extremely flexible and movable so that distances and/or angles between electrical or electronic components to be connected may be easily compensated.

The electrical signal paths of the at least one feedback board connecting device embodied as a flex connector may be embodied in one piece with the electrical signal paths of the feedback board. This means, for example, that no additional connecting unit is required on the feedback circuit board. The flex connectors on the feedback board PCB may be arranged during manufacture in such a way that the flex connectors extend into recesses in the feedback board PCB, for example, in the feedback board passage grid, in which the circuit boards of the power unit are to be inserted, or in recesses in which the heat conducting structure elements on the top of the heat conducting board protrude through the feedback board PCB. This means that no additional area of the feedback board PCB is required for the flex connectors. The connector of the flex connector may be held on the feedback PCB circuit board via connecting bars, for example, made of FR4 or polyimide. This allows the flex connector plug to be cleanly and easily separated from the feedback PCB before the PCBs are inserted.

In the assembled stator module, the interior space that extends between the bottom side of the stator plate and the top side of the heat conducting plate may be filled with a preferably electrically insulating and thermally conductive casting compound. Since there are no mechanical or electrical components between the sensor components on the feedback board, which is arranged on the top side of the heat conducting plate, and the bottom side of the stator plate, casting compound may be introduced into the air volume in this area. The casting compound improves the thermal conductivity and heat that is generated on the stator plate during operation so that it may be optimally dissipated to the heat-conducting plate of the cooling unit with the aid of the casting compound.

Furthermore, a connecting module with a connecting module housing may be provided, in which at least one power supply unit, an energy connecting and distributing structure, and a data connecting and distributing structure are arranged, wherein the energy connecting and distributing structure is connected to a pair of energy supply lines and the data connection and distribution structure is connected to a pair of data lines. With the aid of this configuration, data communication and energy supply may be separated in the connecting module.

### BRIEF DESCRIPTION OF THE DRAWINGS

So that the manner in which the above-recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 shows a perspective view of a planar drive system from above.

FIG. 2 shows a perspective view of the planar drive system from FIG. 1 from below.

FIG. 3 is a perspective exploded view of the stator module from below.

FIG. 4 is a perspective exploded view of the stator module from above.

FIG. 5 is a perspective view of the cooling unit of the stator module from above.

FIG. 6 shows a perspective view of the cooling unit and the feedback board of the stator module from above.

FIG. 7 is a perspective view of the feedback board of the stator module from below.

FIG. 8 shows a perspective view of the power unit and feedback board from below.

FIGS. 9A and 9B show a detailed section of the feedback board from below, and a detailed section of the power unit and feedback board from below.

In the following figures, reference is made to a Cartesian coordinate system. The coordinate system is embodied as a right-hand system by way of example and serves to facilitate understanding of the figures. The positive Z-direction is also referred to below as up and the negative Z-direction as down.

\It should be noted that the figures are only schematic in nature and are not to scale. In this sense, components and elements shown in the figures may be exaggeratedly large or small for better understanding. Furthermore, it should be noted that the reference symbols in the figures have been chosen to be unchanged or similar when they refer to elements and/or components of the same or similar embodiment.

### DETAILED DESCRIPTION

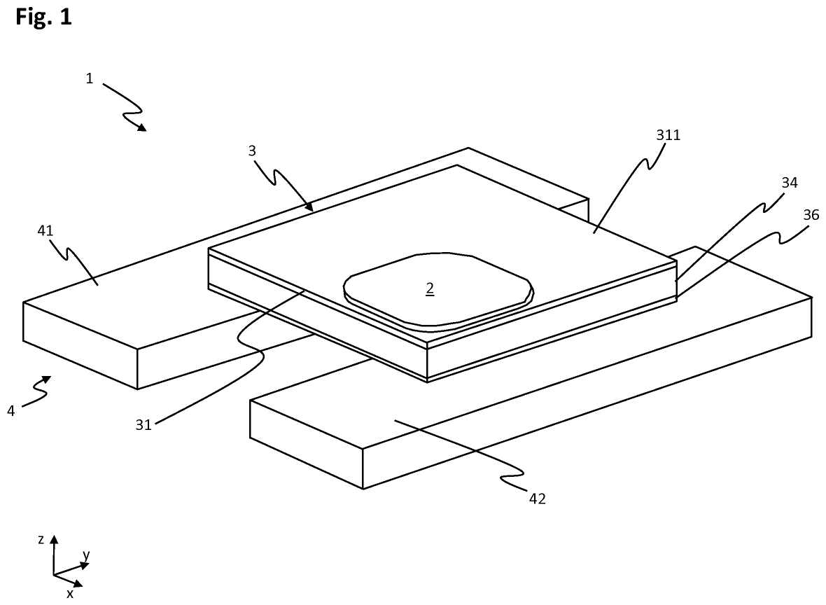

FIG. 1 shows a perspective view of a planar drive system 1 from above, which consists of a rotor 2, a stator module 3, and a carrier device 4. The planar drive system 1 shown in FIG. 1 represents a basic unit, wherein the stator module 3 or the carrier device 4 may be arranged in series with other stator modules or carrier devices and may have any geometry. The assembled stator modules 3 then form a joint surface on which the rotor 2 or further rotors may be moved.

The rotor 2 comprises a carrier surface which, in the embodiment shown in FIG. 1, is essentially square and has a magnet arrangement on its bottom side. The rotor may also have any other shape. The magnet arrangement consists of a plurality of magnets, preferably four, which are arranged in a ring around the edges of the carrier surface on the bottom side. The rotor 2 is generally embodied to be passive without moving parts or connections and may carry any load on the wing. The size of the carrier surfaces may be selected according to the load or the area required.

The stator module 3 comprises a stator plate 31 on the top side. The stator plate 31 is square in the embodiment shown in FIG. 1 but may in principle also have a different geometry. In the stator plate 31, an arrangement of coil conductors 311 is provided, with the aid of which a traveling magnetic field may be generated. The traveling magnetic field may interact with the magnetic arrangement of the rotor 2 in order to lift the rotor 2 in the z-direction and simultaneously move it in the x- and/or y-direction. The rotor 2 may also be tilted around the x- or y-axis or rotated around the z-axis.

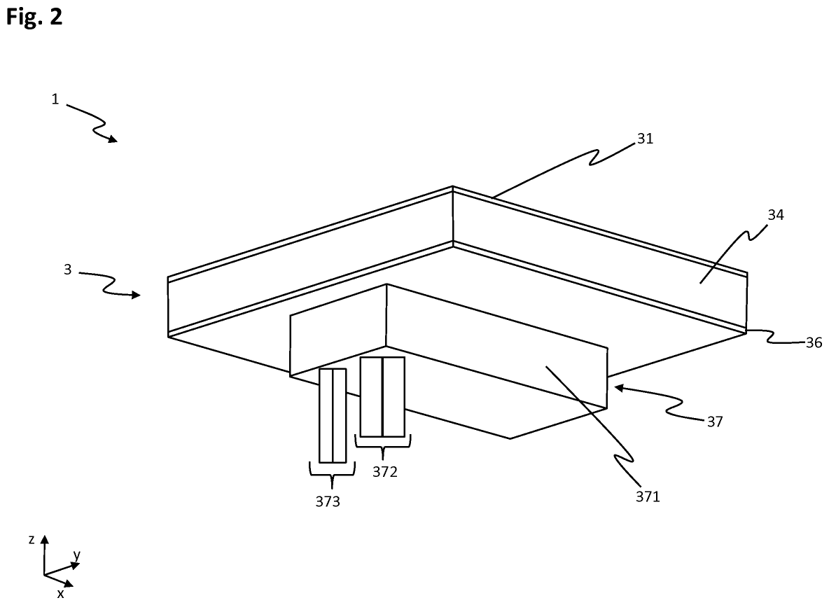

The stator module 3 also comprises a box-shaped cooling unit 34, on the top of which the stator plate 31 is arranged. The cooling unit 34 also serves as the housing of the stator module 3. A base plate 36 is arranged on the rear or bottom side of the box-shaped cooling unit 34. A connecting module 37 is attached to the base plate 36, as shown from below in the perspective view in FIG. 2. The base plate 36 is supported on the carrier device 4, which serves as the machine bed, as shown in FIG. 1. In FIG. 2, however, the carrier device 4 is omitted for better visibility of the connecting module 37.

The carrier device 4 comprises two rod-shaped carrier elements, the first carrier element 41 and the second carrier element 42. The first carrier element 41 and the second carrier element 42 are arranged to the side of the connecting module 37 on the base plate 36, with the base plate 36 resting only partially on the first and second carrier elements 41 and 42 respectively. A further stator module may then be arranged on the side of the first or second carrier element 41, 42 adjacent to the stator module 3 shown in FIG. 1 in order to form a stator module arrangement. The first and second carrier elements 41, 42 may also be extended so that a plurality of stator modules may be arranged one behind the other on the first and second carrier elements 41, 42. The carrier elements 41, 42 may have a hollow profile and have a heat transfer medium flowing through them in order to ensure heat transport to a heat sink.

The connecting module 37 comprises a rectangular connecting module housing 371, on which a pair of energy supply lines 372 and a pair of data lines 373 are arranged. A cooling fin structure may be provided partially or completely on the connecting module housing.

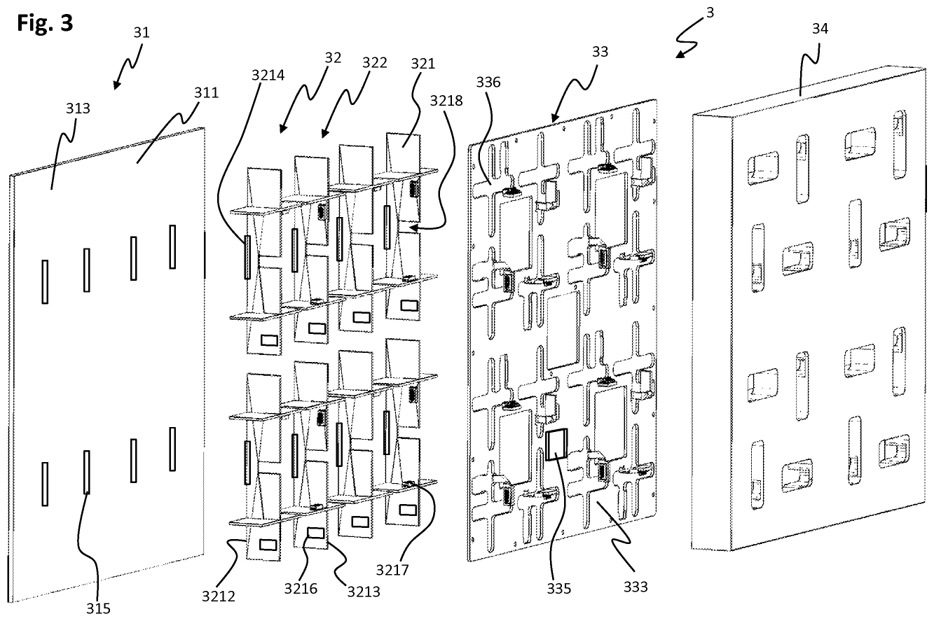

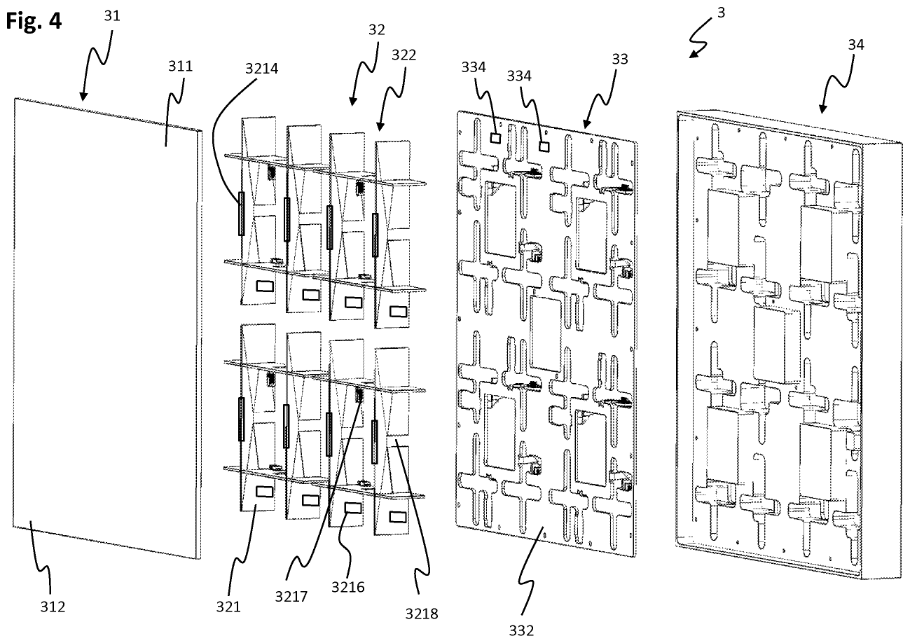

FIG. 3 shows a perspective exploded view of the stator module 3 as seen from below, and FIG. 4 shows a perspective exploded view of the stator module as seen from above. FIG. 3 thus shows the bottom sides of the components enclosed by the stator module 3, whereas FIG. 4 shows the top sides of the components enclosed by the stator module 3. For reasons of clarity, the base plate and the connecting module are shown in FIG. 1 and FIG. 2.

From top to bottom, the stator module 3 consists of the stator plate 31, a power unit 32, a feedback board 33, the cooling unit 34, the base plate 36 and the connecting module 37.

The square stator plate 31 comprising the coil conductor arrangement between a stator plate top side 312 and a stator plate bottom side 313 may be subdivided into a plurality of sectors, for example four sectors, which are essentially identical in structure. Within the sectors, the coil conductor arrangement may be subdivided into further subsectors. However, it is not absolutely necessary to divide the stator plate 31 up into sectors. The coil conductors 311 of the individual sectors or subsectors are electrically insulated from one another and may be energized independently.

Within the sectors of the stator plate 31, the coil conductors 311 are arranged in a plurality of layers arranged one above the other, with coil conductors 311 embodied as metallic conductor tracks in an insulating material being arranged in each layer. The layers may be provided in pairs, with the coil conductors 311 of one layer extending along the x-direction and the coil conductors 311 of the other layer extending along the y-direction, so that the coil conductors 311 in adjacent layers are oriented perpendicular with regard to one another. However, any other sequence of layers is also conceivable. The coil conductors 311 in neighboring sectors within a layer are then again parallel and oriented perpendicular with regard to one another in relation to the x-direction or y-direction.

The coil conductors 311 are contacted on a stator plate bottom side 313 with stator plate connecting devices 315 for the drive current supply. The stator plate connecting devices 315 are arranged on the stator plate bottom side 313 in such a way that they may be electrically connected to drive current circuit board connecting devices 3241 of the power unit 32. The electrical connection between the stator plate connecting devices 315 and the drive current circuit board connecting devices 3214 for drive current output may, for example, be embodied as a solder connection and/or as a plug-socket connection and/or as a press-fit connection. A plug-socket connection or a press-fit connection allows for simple mounting of the circuit boards 321 on the stator plate bottom side 313. In addition, a contact pitch; i.e., a distance between individual contact points, may be freely selected, which offers further optimization potential. Furthermore, press-fit connections ensure mechanical stability of the connection.

The coil conductors 311 in the individual sectors of the stator plate 31 are preferably interconnected as three-phase systems, with the individual phases being supplied with drive current independently of one another via the stator plate connecting devices 315 for the drive current supply.

The power unit 32, which is composed of a plurality of printed circuit boards 321, is arranged on the stator plate bottom side 313. The printed circuit board 321 is formed as a multilayer, rectangular printed circuit board plate, which is equipped with printed circuit board power components 3216, only some of which are shown as examples in the figures. At least some of the printed circuit boards 321 comprise printed circuit board connecting devices 3214 for outputting drive current to the stator plate on the upper, first printed circuit board outer edge 3212 facing the stator plate 31. At least some of the printed circuit boards comprise further connecting devices, which are used, for example, for feeding power to the printed circuit board power components 3216 and any other electrical and electronic components placed on the printed circuit board by the power supply unit.

The PCB power components 3216 are used to generate drive current on the basis of control signals and power fed in. The power is fed into the printed circuit board power components 3216 via the connecting devices for feeding in power.

The arrangement of the printed circuit board power components 3216 on the printed circuit board 321 is selected in such a way that components having ferromagnetic materials are preferably arranged in the lower printed circuit board region facing away from the stator plate 31 adjacent to the second outer edge of the printed circuit board 3213.

As FIGS. 3 and 4 show, the printed circuit boards 321 form a grid pattern 322, with four printed circuit boards 321 each forming a cross-grid structure. In order to be able to plug the four printed circuit boards 321 into one another in order to form the cross grid structure, two printed circuit boards each comprise two printed circuit board insertion gaps at the first printed circuit board outer edge 3212 and two printed circuit boards 321 comprise two printed circuit board insertion gaps at the second printed circuit board outer edge 3213.

The cross grids of four circuit boards 321 may then be arranged on the stator plate bottom side 313, with the circuit board connecting devices 3214 for drive current output engaging the stator plate connecting devices 315 for drive current input on the stator plate bottom side 313.

Instead of a cross grid structure, the PCBs may also be arranged in any other grid structure on the bottom side of the stator plate. The arrangement of the PCBs is determined by the arrangement of the stator plate connecting devices for the drive current supply on the bottom side of the stator plate, into which the PCB connecting devices for the drive current output engage. In all arrangements, the circuit boards protrude downwards, in particular vertically, from the bottom side of the stator plate.

By embodying the power unit 32 with a grid of printed circuit boards 321 arranged perpendicular with regard to the stator plate 31, the printed circuit board area may be selected according to the required configuration, wherein any necessary enlargement of the printed circuit board area in modified embodiments does not result in an additional obstacle from a thermal point of view for heat dissipation from the stator plate 31 to the cooling unit 34.

The vertical arrangement of the printed circuit boards 321 below the stator plate 31 also prevents eddy current effects from occurring within the copper layers in the printed circuit boards 321 due to the movement of the rotor 2 with its magnet arrangement.

Also, negative effects from ferromagnetic materials in the circuit board power devices 3216 may, as described, be reduced by locating such circuit board power devices 3216 away from the stator plate 31 in the lower circuit board region.

As shown in FIGS. 3 and 4, the feedback circuit board 33 follows the power unit 32 in the stator module 3 as viewed from above. The feedback circuit board 33 comprises a feedback circuit board PCB 331, the size of which essentially corresponds to that of the stator plate 31. The feedback circuit board 331 has a multi-layer structure and consists of electrically insulating material in which conductive tracks are embedded. The feedback board PCB 331 also comprises a feedback board passage grid 336, which comprises regularly arranged grid structures that are connected to one another via connecting sections, with island regions being provided in four grid structures.

A plurality of sensor components 334 for detecting the position of the rotor 2 on the stator plate top side 312 are provided on a feedback board top side 332 of the feedback board circuit board 331 facing the stator plate 31, wherein only a few sensor components 334 are shown in the figures for reasons of clarity. The sensor components 334 are, for example, magnetic field sensors, in particular digital or analog 3D Hall sensors, with the aid of which the magnetic field of the magnet arrangement on the rotor 2 may be detected in the various spatial directions. The sensor components 334 are arranged on the top side of the feedback board 332 in a regular pattern, for example, in a grid or diamond structure. The pattern of the sensor components 334 on the feedback PCB circuit board 331 may be selected according to the evaluation method for the rotor position.

At least one component of a feedback communication device 335 is arranged on the feedback board bottom side 333 of the feedback board circuit board 331. The sensor components 334 are connected to the feedback communication device 335, which detects and processes the signals from the sensor components 334 to determine the rotor position. The feedback communication device 335 may then further serve to generate control signals for the circuit board power devices 3216 on the circuit boards 321. Alternatively, the feedback communication device 335 may also process the signals from the sensor components 334 only partially or not at all and transmit the pre-processed or non-processed sensor signals for determining a rotor position to a control unit of the planar drive system 1, which then generates control signals for the printed circuit board power components 3216 from the signals.

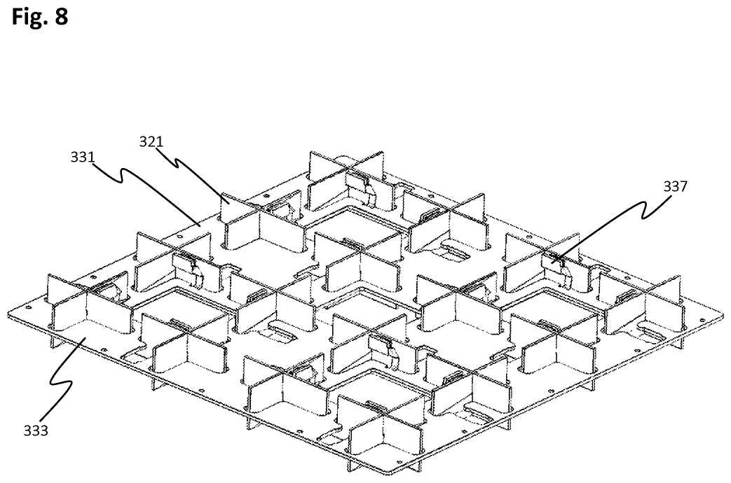

As FIGS. 3 and 4 show, each of the printed circuit boards 321 is provided with a rectangular printed circuit board groove 3218 substantially in the center of the second printed circuit board's outer edge 3213 facing the cooling unit 34. In the stator module 3, as FIG. 8 shows, the printed circuit boards 321 of the power unit 32 pass through the feedback board passage grid 336, which comprises a corresponding cross-grid structure for passing through the cross-grid structure of four printed circuit boards 321, which allows for the printed circuit boards 321 to be connected to the second power unit 32, the circuit boards 321 with the second circuit board outer edge 3213 into the feedback board passage grid 336, wherein a support edge in the circuit board groove 3218 is arranged in an area between two passage openings in the feedback board passage grid 336 on the feedback board top side 332.

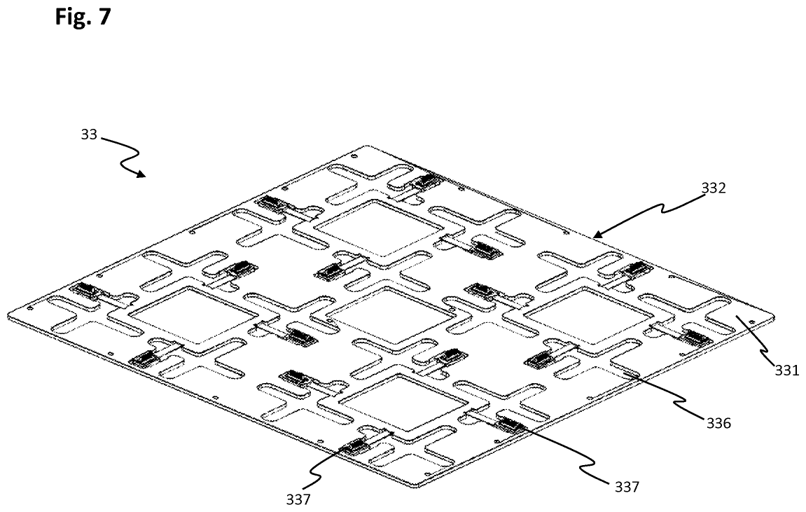

The control signals generated by the components of the feedback communication device 335 on the feedback circuit board 33 are transmitted for control signal output with the aid of feedback circuit board connecting devices 337, which are arranged on the feedback circuit board 33 and may be connected to the control signal circuit board connecting devices 3217 for control signal input on the circuit boards 321. The control signal circuit board connecting devices 3217 for control signal input are formed as sockets on the circuit boards 321, wherein, as FIG. 7 shows, a connector 3371 with a flex band 3372 is provided on the feedback circuit board 33 for each circuit board 321 as feedback circuit board connecting devices 337 for control signal output and forms a flex connector in each case. The arrangement and embodiment of the flex connectors will be discussed in more detail in connection with FIG. 7 to FIGS. 9A and 9B.

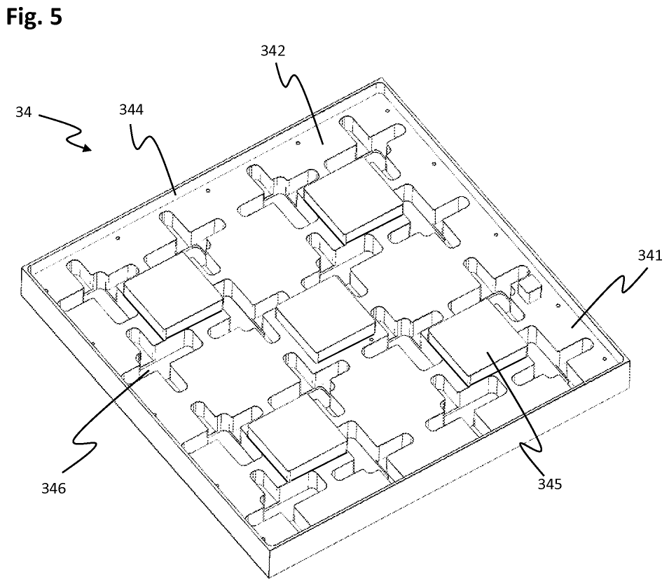

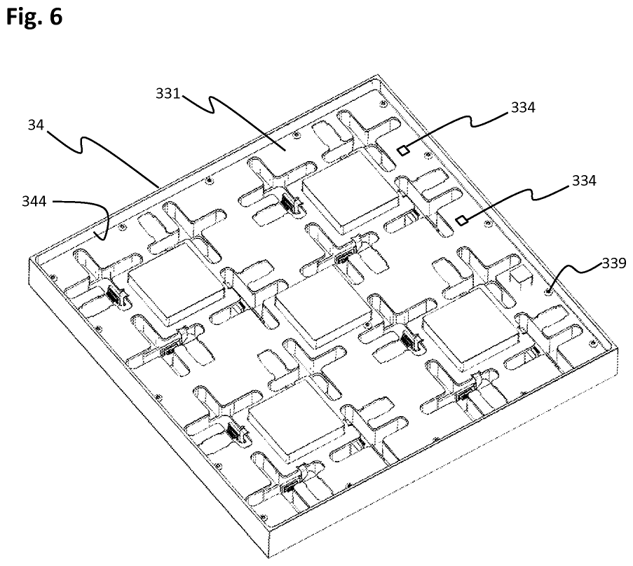

The components of the stator module 3, in particular the stator plate 31, the power unit 32 and the feedback board 33, are arranged in the box-shaped cooling unit 34. A perspective view of the box-shaped cooling unit 34 is shown in FIGS. 5 and 6.

The cooling unit 34 comprises a heat conducting plate 341, which corresponds to the stator plate 31 in terms of dimensions. The heat conducting plate 341 comprises an arrangement of heat conducting structure elements 345 on a heat conducting plate top side 342, which form a pattern. The pattern of the thermally conductive structure elements 345 corresponds to the feedback board passage grid 336 in the area of the aperture opening, which is not used for inserting the circuit boards 321 of the power unit 32.

The heat conducting plate 341 also comprises a heat conducting plate receiving grid 346, which corresponds to the feedback board passage grid 336 in the area of the passage openings for inserting the printed circuit boards 321.

A protruding surround 344 is provided all around the top side of the heat conducting plate 342. In the stator module 3, the stator plate 31 rests with the stator plate bottom side 313 on the surround 344 of the cooling unit 34. Furthermore, in the stator module 3, the feedback board bottom side 333 is arranged on the heat conducting plate top side 342. The heat conducting structure elements 345 of the heat conducting plate 341 then engage through the corresponding passage openings in the feedback board passage grid 336, wherein the heat conducting structure elements 345 of the heat conducting plate 341 abut against the stator plate bottom side 313 to establish thermal contact. The heat conducting structure elements may also have any other shape and may be optimized in their shape, for example, with regard to eddy current effects that occur.

In the heat conducting plate receiving grid 346 of the heat conducting plate 341, passage apertures are also provided for receiving electrical and/or data connecting structures for the components of the stator module 3.

The printed circuit boards 321 inserted into the corresponding recesses in the feedback board passage grid 336 engage with the corresponding recesses in the thermal conductive plate receiving grid 346 in the stator module 3.

In the assembled stator module 3, the interior space extending between the stator plate bottom side 313 and the heat conducting plate top side 342 is filled with a preferably electrically insulating and thermally conductive casting compound. The casting compound may, for example, be a two-component system consisting of a resin and a hardener. The electrical or data connections in the interior, which is filled with casting compound, are protected against casting; i.e., are embodied to be casting-proof.

In contrast to the depiction of the heat conducting plate 341 in FIG. 5, the feedback circuit board 331 according to FIG. 6 is inserted into the heat conducting plate 341. The feedback circuit board 331 may be aligned very precisely to the surround 344. This is of great importance for very precise position detection of a rotor 2 with the aid of the sensor components 334 of the feedback circuit board 33. The more precisely the feedback board circuit board 331 is positioned in the heat conducting plate 341, the more precise the subsequent position detection of the rotor 2. In order to permanently fix a defined position of the feedback board circuit board 331 in the heat conducting plate 341, the feedback board circuit board 331 is fixed with the aid of a plurality of feedback board fastening elements 339. These may, for example, be embodied as screws that are screwed into corresponding threads in the heat conducting plate 341.

As described above and shown in FIG. 7, the feedback board circuit board 331 comprises a feedback board connecting device 337 for each circuit board 321.

FIG. 8 now shows the feedback PCB circuit board 331 in a perspective view from below, with the printed circuit boards 321 of the power unit 32 already pushed through the feedback PCB passage grid 336. The plugs 3371 of the feedback PCB connecting devices 337 are plugged into the corresponding sockets of the control signal PCB connecting devices 3217 on the printed circuit board 321. The flex connector embodiment of the feedback board connecting devices 337 makes it possible to flexibly adjust the insertion depth of the printed circuit boards 321 of the power unit 32 into the feedback board 33 and, as the case may be, to easily adapt it. In addition, any manufacturing tolerances may be compensated for. The flex-connector embodiment of the feedback board connecting devices 337 also makes it possible to optimally utilize the PCB surface of the feedback boards 33.

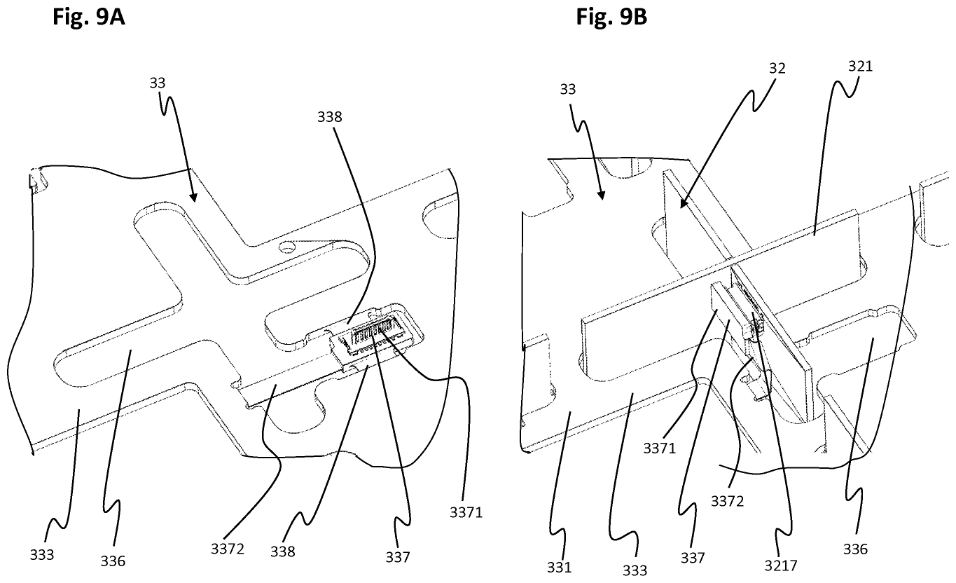

FIGS. 9A and 9B now show enlarged detailed views of areas of the feedback PCB circuit board 331 according to FIG. 7 and FIG. 8. FIG. 9A shows the feedback PCB circuit board 331 according to FIG. 7 in a state after the manufacture or before the assembly of the feedback PCB circuit board 331. FIG. 9B, on the other hand, shows the feedback PCB circuit board 331 according to FIG. 8 with the PCBs 321 pushed through and contacted with the aid of the flex connectors.

As FIG. 9A shows, when manufacturing the feedback board 33, the flex connectors may be arranged in a space-saving manner in the feed-through openings in the feedback board feed-through grid 336 for inserting the printed circuit boards 321. The flex band 3372 of the flex connectors extends at the feedback board level from the feedback board PCB 331 into a passage aperture, wherein the connector 3371 is secured to the feedback board PCB 331 during manufacture with the aid of connecting bars 338. The connecting bars 338 each connect the connector 3371 to the side of the feedback board PCB 331 and thus hold the connector 3371 in the plane of the feedback board PCB 331. The connecting bars 338, which are made of FR4 or polyamide, for example, may then be easily cut through before the PCBs 321 are inserted in order to clear the apertures in the feedback board passage grid 336 for inserting the PCBs 321.

After cutting the connector 3371 out of the feedback PCB circuit board 331, the connector 3371 may, as FIG. 9B shows, be twisted quite flexibly with the aid of the flex band 3372 so that the connector 3371 may be plugged into a control signal PCB connecting device 3217 embodied as a socket on the PCB circuit board 321 after the PCB circuit boards 321 have been plugged into the through-holes in the feedback PCB through-grid 336 of the feedback PCB circuit board 331. The flex band 3372, which is connected to the feedback PCB circuit board 331, is embodied to be casting-proof, whereas the plug-socket connection is located outside the casting area, which extends in the assembled stator module 3 between the stator plate bottom side 313 and the heat conducting plate top side 342.

The invention has been described in detail by preferred embodiments. Instead of the embodiments described, other embodiments are conceivable which may comprise further modifications or combinations of the features described. For this reason, the invention is not limited by the disclosed embodiments, since other variations may be derived from them by a person skilled in the art without leaving the protective scope of the invention.

TABLE 1
References

1 Planar drive system
2 Rotor
3 Stator module
31 Stator plate
311 Coil conductor
312 Stator plate top side
313 Stator plate bottom side
315 Stator plate connecting device
32 Power unit
321 Circuit board
322 Grid pattern
3212 First PCB outer edge
3213 Second PCB outer edge
3214 Drive current circuit board connecting device
3216 Printed circuit board power component
3217 Control signal circuit board connecting device
3218 PCB groove
33 Feedback board
321 Feedback board PCB
323 Feedback board top side
333 Feedback board bottom side
334 Sensor component
335 Feedback communication device
336 Feedback board passage grid
337 Feedback board connecting device
3371 Plug
3372 Flex tape
338 Connecting bar
339 Feedback board fastening element
34 Cooling unit
341 Heat conducting plate
342 Top side of heat conducting plate
343 Heat conducting plate bottom side
344 Surround
345 Heat conducting structure element
346 Heat conducting plate receiving grid
36 Base plate
37 Connecting module
371 Connecting module housing
372 Energy supply cable pair
373 Data line pair
4 Carrier device
41 First carrier element
42 Second carrier element

What is claimed is:

1. A stator module for electromagnetically driving a rotor in a planar drive system, the stator module comprising:
a stator plate which comprises a coil conductor to which a drive current is applicable for generating a magnetic field driving the rotor via a stator plate top side,
at least one stator plate connecting device arranged on a stator plate bottom side for feeding in the drive current, and
a power unit which faces the stator plate bottom side and comprises at least one circuit board, the circuit board projecting downwards or vertically from the stator plate bottom side,
wherein the circuit board comprises a drive current printed circuit board connecting device configured for electrical contact with the stator plate connecting device for drive current output, and a control signal printed circuit board connecting device configured for control signal input, and
wherein said circuit board further comprises circuit board power devices configured for generating drive current based on input control signals and input power;
a feedback board which comprises at least one sensor component configured for detecting the position of the rotor and a feedback communication device configured for generating control signals and processing data,
wherein a feedback board passage grid is provided in the feedback board, and
wherein the feedback board comprises at least one feedback board connecting device configured for data contact with the control signal printed circuit board connecting device, for control signal output; and
a box-shaped cooling unit which comprises a heat conducting plate with a projecting circumferential surround and heat conducting structure elements on a heat conducting plate top side, a heat conducting plate receiving grid being provided in the heat conducting plate, the stator plate bottom side abutting on the projecting circumferential surround of the cooling unit,
wherein a feedback board bottom side is arranged on the heat conducting plate top side and the heat conducting structure elements of the heat conducting plate engage through the feedback board passage grid and abut against the stator plate bottom side, and
wherein the circuit board of the power unit engages at least partially through the feedback board passage grid and engages in the heat conducting plate receiving grid.

2. The stator module according to claim 1, wherein the circuit board projects vertically from the stator plate bottom side.

3. The stator module according to claim 1, wherein:
the power unit comprises a plurality of rectangular circuit boards, and
wherein the plurality of rectangular circuit boards form a grid pattern oriented at a right angle with respect to the stator plate bottom side.

4. The stator module according to claim 3, wherein:
each rectangular circuit board comprises a first circuit board outer edge that abuts on the stator board bottom side, and
wherein each rectangular circuit board further comprises, in a second circuit board outer edge opposite the first circuit board outer edge, a circuit board groove with a bearing edge that bears against the feedback board top side.

5. The stator module according to claim 1, wherein the at least one feedback board connecting device for control signal output is configured as a flex connector.

6. The stator module according to claim 5, wherein the electrical signal paths of the at least one feedback board connecting device configured as a flex connector are integrally arranged with the electrical signal paths of the feedback board.

7. The stator module according to claim 1, wherein an inner space extending between the stator plate bottom side and the heat conducting plate top side is filled with a preferably electrically insulating and thermally conductive casting compound.

8. The stator module according to claim 1, further comprising:
a connecting module comprising a connecting module housing in which at least a power supply, an energy connection and distribution structure, and a data connection and distribution structure are arranged;
wherein the energy connection and distribution structure is connected to a pair of power supply lines and the data connection and distribution structure is connected to a pair of data lines.

9. A stator module for electromagnetically driving a rotor in a planar drive system, comprising:
a stator plate,
a power unit, which comprises at least one printed circuit board projecting downwards from a stator plate bottom side,
a feedback board, in which a feedback board passage grid is provided, and
a box-shaped cooling unit, which comprises a heat conducting plate having a projecting circumferential surround,
wherein a heat conducting plate receiving grid is provided in the heat conducting plate, and
wherein the stator plate bottom side abuts on the projecting circumferential surround of the cooling unit.

10. The stator module according to claim 9, wherein the printed circuit board projects vertically from the stator plate bottom side.

11. The stator module according to claim 9, wherein:
the power unit comprises a plurality of rectangular circuit boards, and
wherein the plurality of rectangular circuit boards form a grid pattern oriented at a right angle with respect to the stator plate bottom side.

12. The stator module according to claim 11, wherein:
each rectangular circuit board comprises a first circuit board outer edge that abuts on the stator board bottom side, and
wherein each rectangular circuit board further comprises, in a second circuit board outer edge opposite the first circuit board outer edge, a circuit board groove with a bearing edge that bears against the feedback board top side.

13. The stator module according to claim 9, wherein:
a feedback board bottom side is arranged on a heat conducting plate top side, and heat conducting structure elements of the heat conducting plate engage through the feedback board passage grid and abut against the stator plate bottom side, and
wherein the printed circuit board of the power unit engages at least partially through the feedback board passage grid and engages in the heat conducting plate receiving grid.

14. The stator module according to claim 9, wherein:
the power unit comprises a plurality of rectangular circuit boards, and
wherein the plurality of rectangular circuit boards form a grid pattern oriented at a right angle with respect to the stator plate bottom side.

15. The stator module according to claim 9, further comprising at least one feedback board connecting device for control signal output, configured as a flex connector.

16. The stator module according to claim 15, wherein electrical signal paths of the at least one feedback board connecting device configured as a flex connector are integrally arranged with the electrical signal paths of the feedback board.

17. The stator module according to claim 9, wherein an inner space extending between the stator plate bottom side and the heat conducting plate top side is filled with an electrically insulating or thermally conductive casting compound.

18. The stator module according to claim 9, further comprising:
a connecting module comprising a connecting module housing in which at least a power supply, an energy connection and distribution structure, and a data connection and distribution structure are arranged,
wherein the energy connection and distribution structure is connected to a pair of power supply lines and the data connection and distribution structure is connected to a pair of data lines.

19. A planar drive system comprising:
a plurality of stator modules, and
at least one rotor;
wherein each stator module comprises:
a stator plate,
a power unit which comprises at least one printed circuit board projecting downwards from a stator plate bottom side,
a feedback board in which a feedback board passage grid is provided, and
a box-shaped cooling unit which comprises a heat conducting plate having a projecting circumferential surround;
wherein a heat conducting plate receiving grid is provided in the heat conducting plate,
wherein the stator plate bottom side abuts on the projecting circumferential surround of the cooling unit, and
wherein the plurality of stator modules form a joint surface on which the rotor is moveable.
